(19) United States
(12) Patent Application Publication
(10) Pub. No.: US 2011/0035235 A1
(43) Pub. Date: Feb. 10, 2011

(54) System and Method for Processing Radiological Information Utilizing Radiological Domain Ontology

(76) Inventors: Charles R. Hale, Trumbull, CT (US); Donald E. Salz, New Rochelle, NY (US); Yihong Ding, Westport, CT (US)

Correspondence Address: Woods Oviatt Gilman LLP, 700 Crossroads Bldg, 2 State St., Rochester, NY, 14614, US

(21) Appl. No.: 12/556,923

(22) Filed: Sep. 10, 2009

Related U.S. Application Data
(63) Continuation-in-part of application No. 12/535,825, filed on Aug. 5, 2009.

(51) Int. Cl. G06Q 50/00; G06N 5/02

(52) U.S. Cl. 705/3; 706/46

(57) ABSTRACT

The present invention is directed in general to a system and method that employs radiological report domain ontology to specify and model radiological report information as knowledge. A system and method are provided that allow for consulting the ontology in the context of the model that the ontology fulfills. The result of consulting the ontology is validated, identified and classified radiological report information that is based on information provided in the consultation.

### CROSS REFERENCE TO RELATED APPLICATIONS

This application is a continuation-in-part of prior U.S. patent application Ser. No. 12/535,825, filed Aug. 5, 2009. The content of U.S. patent application Ser. No. 12/535,825 is hereby incorporated by reference in its entirety.

### TECHNICAL FIELD

The present invention is directed in general to imaging technologies and more particularly to medical imaging and Picture Archiving and Communication Systems (PACS) having an image display wherein the identification, validation and classification of radiological information is desired, and more importantly, that the reporting of radiological information conforms to this paradigm. A system and method are provided to define various aspects of radiological report information processing as concept properties represented by a vocabulary of one or more instances of ontology concepts. Even further, a system and method are provided for consulting a radiological report domain ontology wherein non-radiological knowledge is modeled as radiological domain knowledge and radiological image observations expressed in a report can be identified, validated and classified in a consistent manner. Users are able to quickly, accurately and consistently reference and report radiological observations.

### BACKGROUND OF THE INVENTION

In medical imaging, Picture Archiving and Communication Systems (PACS) are a combination of computers and/or networks dedicated to the storage, retrieval, presentation and distribution of images. While images may be stored in a variety of formats, the most common format for image storage is Digital Imaging and Communications in Medicine (DICOM). DICOM is a standard in which radiographic images and associated meta-data are communicated to the PACS system from imaging modalities for interaction by end-user medical personnel.

Medical personnel spend a significant amount of their time addressing administrative tasks. Such tasks include, for example, documenting patient interaction and treatment plans, preparing billing, reviewing lab results, recording observations and preparing reports for health insurance. Time spent on performing such tasks diminish the time available for patients, and in some instances lead to inaccurate and hastily compiled reports or records when personnel are faced with the need to see multiple patients.

In order to address time deficiency issues, the current trend in the medical field is to automate as many health care related processes as possible by leveraging various technologies, and thereby freeing up personnel to spend more time with patients rather than performing administrative tasks. Another objective in this arena is to ensure that administrative tasks are accomplished in an accurate and consistent manner. One approach to achieving this objective is to provide a standardized representation for healthcare related data, particularly within the various specialty areas, such as radiology, cardiology, etc.

Health care data is not easily reusable by disparate groups in the radiological field because it is stored with different methods and in different formats across a wide range of information technology. Various initiatives by groups and organizations across the globe, including the National Institutes of Health, Food and Drug Administration, and other medical bodies, have driven a set of standards for the consolidation of medical information into a common framework. One such standard is RadLex, which is a standard radiological lexicon proposed by the Radiological Society of North America, for uniform indexing and retrieval of radiology information. RadLex is a taxonomy having class hierarchies. RadLex functions essentially as a dictionary of terms and the notes relationships among the terms. RadLex has some crucial limitations. The most significant of these limitations is the inability to support radiological findings and the relationships between the findings and the characteristics of the findings. What is needed is an extension to RadLex—an extension that provides domain specific modeling, which can then be applied to or utilized by a wide variety of applications such as report tools, treatment analysis programs, tools for classification and verification of radiological information, and systems for improving radiological work flow. Such an extension would utilize an ontology that is domain specific in order to process radiological information.

Ontology is a data model for the modeling of the concepts and the relationship between a set of concepts. Ontologies are utilized to illustrate the interaction between the set of concepts and corresponding relationships within a specific domain of interest. Thus, the concepts and the relationships between the concepts can be represented in readable text, wherein descriptions are provided to describe the concepts within a specific domain, and the relationship axioms that constrain the interpretation of the domain specific concepts.

Numerous current products and research efforts offer tools that streamline data integration. These include centralized database projects such as the Functional Magnetic Resonance Imaging Data Center and the Protein Data Bank, distributed data collaboration networks such as the Biomedical Informatics Research Network, commercial tools for data organization, and systems for aggregating healthcare information such as Oracle Healthcare Transaction Base. In addition, tools have been developed to automatically validate data integrated into a common framework. Validation calls for techniques such as declarative interfaces between the ontology and the data source and Bayesian reasoning to incorporate prior expert knowledge about the reliability of each source.

While automated data integration and validation require fewer human resources, they necessitate that data have well-defined a priori structure and meaning.

There are a number of functionalities not provided by the systems described earlier. Accordingly, there is a need for a comprehensive system which is capable of enabling researchers to: 1) efficiently enter heterogeneous local data into the framework of the Unified Medical Language System (UMLS) based ontology, 2) make necessary extensions to the standardized ontology to accommodate local data, 3) validate the integrated data using expert rules and statistical models defined on data classes of the standardized ontology, 4) efficiently upgrade data that fails validation, and 5) leverage the integrated data for reporting functionality and predictions. This is particularly the case in the field of radiology, and even more specifically within the various domains therein such as mammography.

To overcome some of the deficiencies earlier described, some existing systems have attempted to minimize the amount of effort that may be required to report on radiological findings. However, these systems suffer from a myriad of drawbacks. Essentially these solutions have: a non standard library or vocabulary; no error, terminology, or consistency checking; no ability to utilize meta-history; and no collaboration or tool that can be used by other application programs.

The shortcomings of the prior art are overcome and additional advantages are provided through the provision of a method for utilizing ontology that is based upon data obtained from unstructured and semi-structured knowledge sources to provide identification, validation and classification of radiological report concepts.

The present invention addresses these needs as well as other needs.

### SUMMARY OF THE INVENTION

The present invention is directed in general to a system and method that employs radiological report domain ontology to specify and model radiological report information as knowledge. The present invention provides a methodology to consult the domain ontology and provide report information in reference to a subject, report or images that may be specific to one or more than one modality. The method comprises defining one or more aspects of radiology functions as concept properties represented by a vocabulary of one or more instances of the radiological report domain ontology.

The radiological domain ontology declares and fulfills a model of radiological domain knowledge by employing a context that defines a set of domain knowledge and the relationships among said set of domain knowledge with respect to imaging modalities when necessary or appropriate. In other words, this ontology can contain information that is non-modality specific. The invention validates that an information item of interest relating to said subject or imaging modalities is radiological in nature and resides in the domain knowledge. The invention further identifies a definitive concept of said information item from within said domain of knowledge and classifies the information item as an object with properties. The object's properties represent relationships among said findings and finding characteristics or concepts.

Exemplary embodiments of the present invention relate to a solution for the extraction of information from unstructured knowledge sources of radiological report information and non-radiological knowledge sources, for example clinical information, patient history or clinical/surgical consultation. Further, ontological relationships are inferred between the extracted information. The inferred ontological relationships are identified, verified and classified.

### BRIEF DESCRIPTION OF THE DRAWINGS

The above-mentioned features and other features and advantages of this invention, and the manner of attaining them, will become apparent and be better understood by reference to the following description of the invention in conjunction with the accompanying drawing, wherein:

FIG. 1 is an illustrative block diagram of a radiological report domain ontology comprising other imported ontologies, and concepts;

FIG. 2 is an illustrative diagram of a defined concept and instances thereof that represent a vocabulary for expressing the knowledge of FIG. 1;

FIG. 3 is a data and flow diagram of an exemplary process for validating radiological report information;

FIG. 4 is a data and flow diagram of an exemplary process for validating that a given radiological report information is within a given radiological context;

FIG. 5 is a data and flow diagram for editing, i.e., addition/deletion, of an instance of a given radiological informational item G concept, to/from the radiological report domain ontology;

FIG. 6 is a data and flow illustration for editing, i.e., addition/deletion, of an instance expression of a given radiological report informational item G, to/from the instance in the radiological report domain ontology;

FIG. 7 is a data and flow illustration for providing a list of individual radiological finding related characteristic concepts and finding characteristic individuals for a valid image finding I, in the modeled ontology; and

FIG. 8 is a block diagram generally illustrating a computing environment in which the invention may be implemented.

### DETAILED DESCRIPTION OF THE INVENTION

Generally, the system and methods described herein may be implemented in hardware, software or a combination thereof. The disclosed embodiments are intended to be illustrative since numerous modifications and variations thereof will be apparent to those of ordinary skill in the art.

This document is organized as follows. In the first section, an overview of the techniques and implementation necessary to provide a consistency of terminology in radiological reporting in accordance with the present invention are provided and described. In the next section, an exemplary implementation of particular features of the present invention for modeling radiological report information as knowledge is discussed. Following this, other aspects of the invention as they pertain to use and function of the invention are discussed. Finally, an exemplary computer environment for the implementation and use of the invention is described.

The present invention employs radiological domain ontology to specify and model radiological report information as knowledge. A system and method are provided to allow for consulting the ontology in the context of the model the ontology fulfills. Consulting the ontology results in identified, validated and classified radiological report information that is based on the information provided in the consultation.

More specifically, the present invention also relates to a solution for the extraction of information from unstructured or non-radiological knowledge sources. A set of subject-matter specific relationships are established as a logical foundation for the ontological subject matter domain. The subject-matter specific relationships can be derived partially from a pre-existing information source (e.g., RadLex, the radiological lexicon), other ontology, and partially from the knowledge that needs to be modeled for an identified subject. For example, ontology on the subject of mammography will use lumps or masses as topic concepts. The relationships may correspond to disease-specific relationships such as biopsy, additional exam, symptoms, location, further treatments, etc. In another example, a report may utilize clinical indications as a concept. In this instance a relationship may correspond to specific imported ontology that provides a knowledge source, such as anatomic location ontology, follow-up procedure ontology, etc. Once the subject-matter specific relationships have been established, the unstructured/non-radiological knowledge sources are parsed in order to identify topic headings and content texts that are associated with respective topic headings within the knowledge source. The context texts that are identified within the knowledge source correspond to the predetermined subject-matter specific relationship. It should be understood that the source of the unstructured/non-radiological information is varied and includes such sources as spoken words, a user's typing, reports or systems or applications that need to determine if a piece of information is suited for radiological reports.

In an embodiment of the present invention, non-radiological information is derived from meta-historical information. Meta-historical information as used herein refers to information that may be relevant to the patient which is derived from sources other than just a patient history. More specifically, sources for meta-historical information may include ancillary sources such as family history, genetic information or other demographic type data.

The textual content (finding) is then analyzed to identify references to concepts—wherein concept reference descriptors (finding characteristics) can be obtained and presented to a system user or to other down-line applications or systems. For each concept reference descriptor that is identified, an analysis is performed of relevant report content information to identify references to concept descriptors that exist within the report content information.

The present invention utilizes ontology to define a set of knowledge and relationships among the knowledge thereby employing a context. For example, if there is a finding of a tumorous mass in an image, the system knows what other information would be relevant to that finding such as size, density, location and other characteristics that apply to that finding, as well as the relationships between the findings and finding characteristics. The set of knowledge includes other specific ontology. The knowledge set may then be applied when a report is being constructed.

Ontological models are used to talk about “things.” An important vocabulary tool is “relations” between things. An ontology model itself does not include the “things,” but introduces classes and relations, which can then be used as a vocabulary for talking about and classifying things. In the field of medicine, ontology is used in solving problems in the field of medical terminology, including the organization of copious amounts of data, the alignment and integration of heterogeneous knowledge and disambiguates in terminology.

The present invention provides a combination of an intelligent database and system, which can provide not only stored information but also information which can be determined or derived by knowledge of the technical domain.

In an embodiment of the present invention, the radiological domain ontology is constructed using combinations of one or more of the following World Wide Web Consortium standards:

RDF—Resource Description Framework

RDFS—RDF Schema

OWLDL—Web Ontology Language Description Logic version

The radiological domain ontology is utilized to define a plurality of specific concept ontology which along with other report concepts may then be utilized to construct a radiological report domain ontology.

Although the following discussions and the present invention are described in relation to a biological imaging report system, it should be understood that the invention is also applicable to other information/imaging technologies, systems or reports.

Ontology is a philosophy of what exists. In computer science, ontology is used to model entities of the real world and the relations between them to create common dictionaries for their discussion. Basic concepts of ontology include 1) classes of instances/things, and 2) relations between the classes, as described herein below. Ontology provides a vocabulary for talking about things that exist.

Relations, also referred to as properties, attributes and functions are specific associations of things with other things. Relations can include:
Relations between things that are part of each other, e.g., between a car and its tires;
Relations between things that are related through a process such as the process of creating the things, e.g., a painter and his/her painting; and
Relations between things and their measures, e.g., a tumorous mass and its size.

Some relations also associate things to fundamental concepts such as size, which would be related to large or small, or morphology which would be related to the shape of a mass such as round or linear.

Relations play a dual role in ontology. In one instance, individual things are referenced by way of properties, e.g., a person by a name or characteristic, or music by its title and author. In another instance, knowledge being shared is often a property of things too. A thing can be specified by some of its properties, in order to query for the values of its other properties.

Not all relations are relevant to all things. It is convenient to discuss the domain of a relation as a “class” of things, also referred to as a category. Often domains of several relations may coincide.

Imaging systems as discussed herein include those wherein image manipulation, image attributes, and features of an imaging system are required to be intuitively and easily analyzed and/or reported, including non-medical systems, visual analysis and diagnostic tools, and other visual user interface environments. Aside from the exemplary environment described herein, the system and method of the present invention is equally applicable to reporting in other radiological domains and for other imaging modalities. The use in other applications or by other systems or tools are anticipated and within the scope of the present invention.

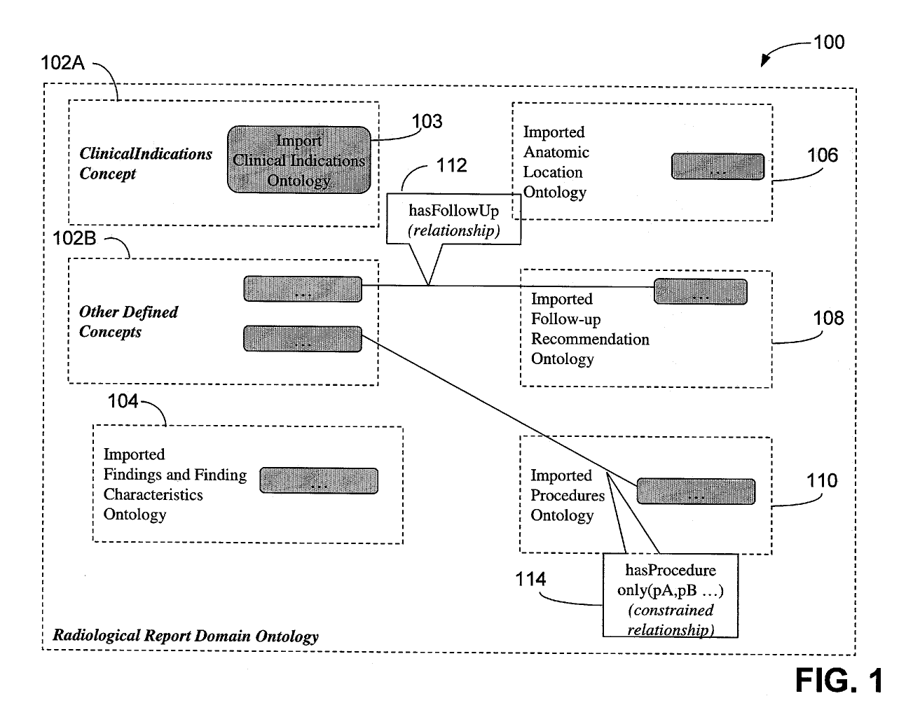

In an embodiment of the present invention, a radiological report domain ontology 100 that both declares and fulfills a model of radiological report domain knowledge may be described as shown in FIG. 1.

Referring initially to FIG. 1, pathological, physiological and iatrogenic entities and pathological, physiological and iatrogenic observations may be modeled as radiological concepts. Therefore, in connection with a particular image that is being observed or considered by a radiologist or a study that is to be reported, there may be a number of concepts 102A, 102B. These concepts 102A, 102B may themselves be defined by one or more ontology. For example the clinical indications concept 102A is defined by imported clinical indications ontology 103. Various aspects of radiological information may be represented, described or defined by one or more specific radiological information ontology such as, Findings and Finding Characteristics Ontology 104, Anatomic Location Ontology 106, Follow-up Recommendation Ontology 108, Procedures Ontology 110, etc. These ontologies in combination with other concepts 102 may be employed to further construct the radiological report domain ontology 100.

The present invention builds upon the fact that attributes within the realm of radiological knowledge (including diagnosis, anatomic location, and follow-up recommendation, of pathological, physiological, and iatrogenic entities) and pathological, physiological, and iatrogenic observations may be modeled conceptually as radiological ontology to provide validation, identification and classification of radiological report information. In operation, a particular one of the concepts 102A, 102B may be associated and related to Follow-up Recommendation Ontology 108 by a relationship and object property. For instance, the relationship—“has follow-up” 112 is associated with the concept 102B. Further, there may be Procedure Ontology 110 which may be applicable to any one or more of the concepts 102. A relationship—“has Procedure” 114 may be defined for one of the concepts 102B, thus associating one or more procedures with the assigned concept. It should be understood that the relationship “has Procedure” 114 may be characterized by constraints, which further qualify the concept 102B. The relationships between the radiological concepts 102B may therefore be modeled as object properties, i.e., “has Follow-up” 112, and “has Procedure” 114 of the radiological report domain ontology.

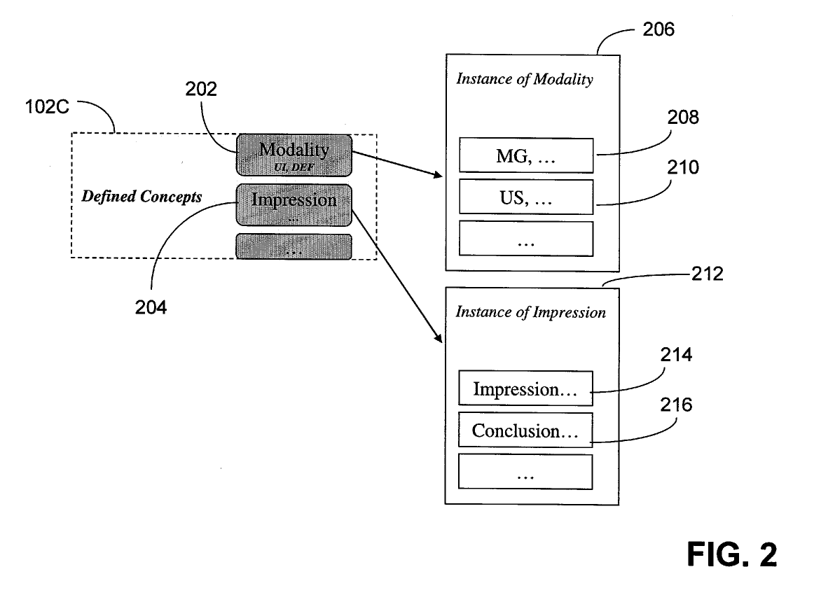

Consistent with the foregoing, the modeled ontology may further contain constraints on radiological findings, radiological finding characteristics, concepts and relationships. Further still, the ontology may also contain concept properties, such as relevance to a modality or impression. It should be understood that certain concepts may be defining concepts from which individual instances may be utilized to represent the vocabulary representing the concept. This aspect is best illustrated with reference to FIG. 2.

As shown in FIG. 2, defined concepts 102C may include the concepts of modality 202 and impression 204. Any of these concepts 202, 204 may be a defining concept from which an instance may be derived to further represent or further describe a finding, finding characteristic or report item. As illustrated in FIG. 2, modality 202 may have a modality instance 206, characterized by further properties, descriptions or qualifiers such as mammography 208, ultrasound 210 and so forth. Similarly, impression 204 may have an impression instance 212 characterized by further descriptions or qualifiers such as impression description 214, conclusion 216, etc.

Accordingly, these concept instances can be utilized as the vocabulary for describing concept 102C. Even further, the concept instances 206, 212 provide a vocabulary guide in the sense that a radiologist may be restricted in some instances to only one of the provided properties, descriptions or qualifiers 208, 210, 214, 216 from within each of the relevant instances. For example, the modality associated with the concept 202, may be selected to be either mammography 208 or ultrasound 210. In other words, when a report is being created to describe a particular study, the modality of that particular study may not be both mammography and an ultrasound. Similarly, certain concepts may have follow-ups and others may not. The ontology, relationship and constraints would thus prevent the inadvertent reporting of a follow-up in association with a concept that does not support such a feature.

In order to facilitate reference and identification of the parts of an image for the purpose of diagnosis or analysis of the subject, the various parts of the image may need to be reported on. The present invention provides a system and method for consulting the radiological report domain ontology earlier described, for providing validation, identification and classification of the report information.

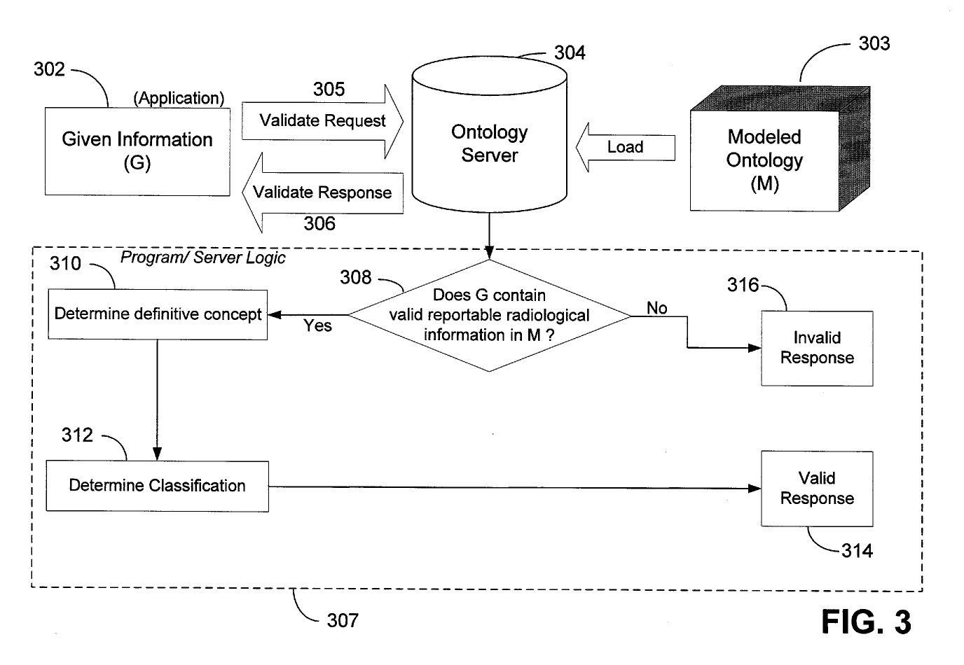

For example, and as illustrated in FIG. 3, a report application program 302 having a given information G, initiates a validation request 305 to an ontology server 304. The ontology server 304 is loaded with a modeled ontology M 303 of the present invention, such as described by FIG. 1. Program/server logic 307, which may reside on the ontology server 304 as shown or reside on another device having access to the ontology server 304, accepts the validation request 305 and provides a validation response 306. In operation, logic 307 determines at step 308, if the given information G contains valid radiological report information in the modeled ontology M. If valid information is contained therein, identification of a definitive concept that resides in the domain is determined at step 310. Classification of the given information G within the domain is determined at step 312. Following this, a valid response indication 314, is provided in the validation response 306. In the event that the given information G was not valid radiological report information in M as determined at step 308, an invalid response indication 316, is provided in the validation response 306.

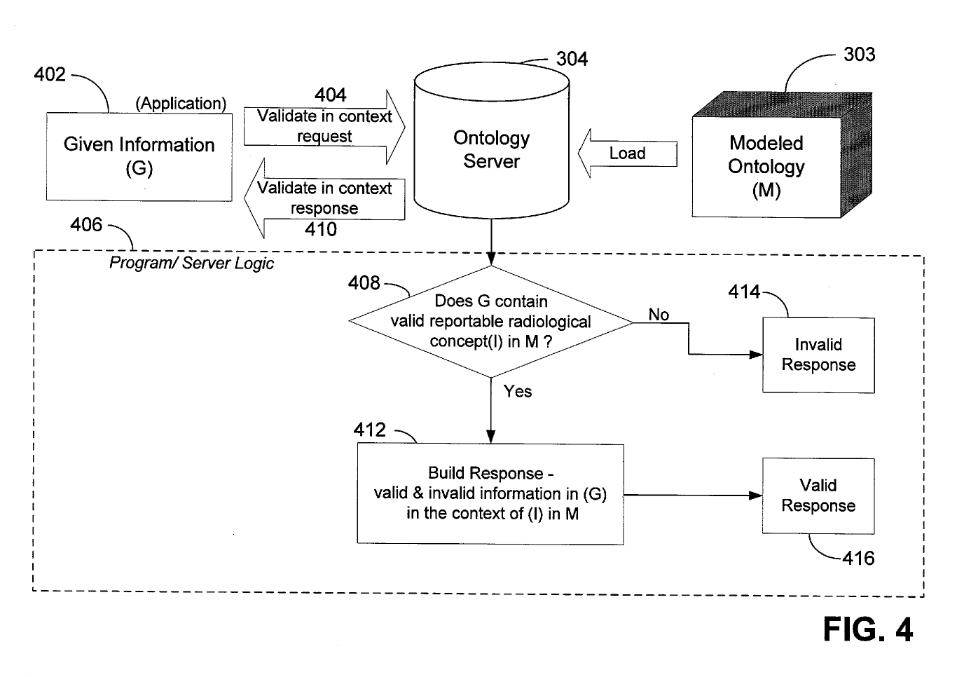

The given information G is also evaluated by the present invention to determine if the given information G is in context for the report that is under consideration. As shown in FIG. 4, a validate in context request 404 is initiated from application program 402 to the ontology server 304. In operation, program/server logic 406, determines if G contains a valid radiological report concept I within the modeled ontology M 303, at step 408. If the result of that inquiry is dispositive then an invalid response signal 414 is conveyed to validate in context response 410 and back to the application program 402. Conversely, if the result of the inquiry is affirmative, a response indicating that the given information G is valid in the context of the ontology M, a valid response signal 416 is built at step 412 and then sent back to the application program 402.

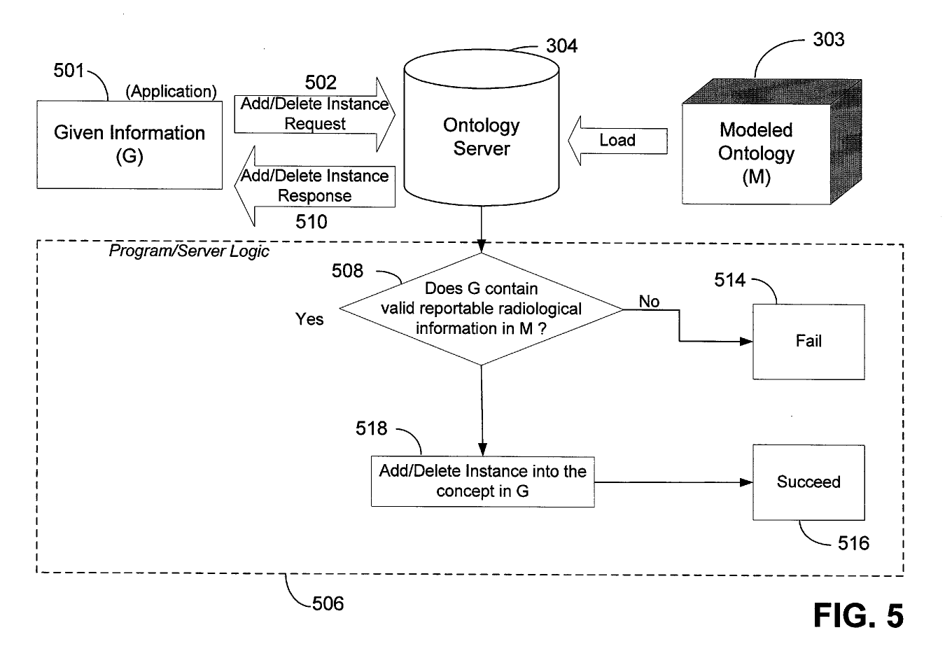

In a further aspect of the present invention, and as illustrated in FIG. 5, a given information concept G 501 may be added or deleted as an instance of a radiological concept stored in the ontology server 304. This feature enables learning, growth and expansion of the system and its knowledge. The deletion or addition of the information depends on whether or not such concept contains valid radiological report information within the modeled ontology M 303 as determined by server logic 506. In operation, an add/delete instance request 502 is initiated by an application 504 for given information G 501. Program/server logic 506 determines if information G contains valid radiological information in the modeled ontology M 303, at step 508. If the result of that determination is false, then a fail signal 514 is returned in the add/delete instance response 510, to the initiating application 504. Conversely, if the result of the determination is true, then a success signal 516 is generated and the appropriate action (i.e., addition or deletion) of the given information G as an instance of a radiological concept is performed at step 518. A similar operation is also provided for instance.

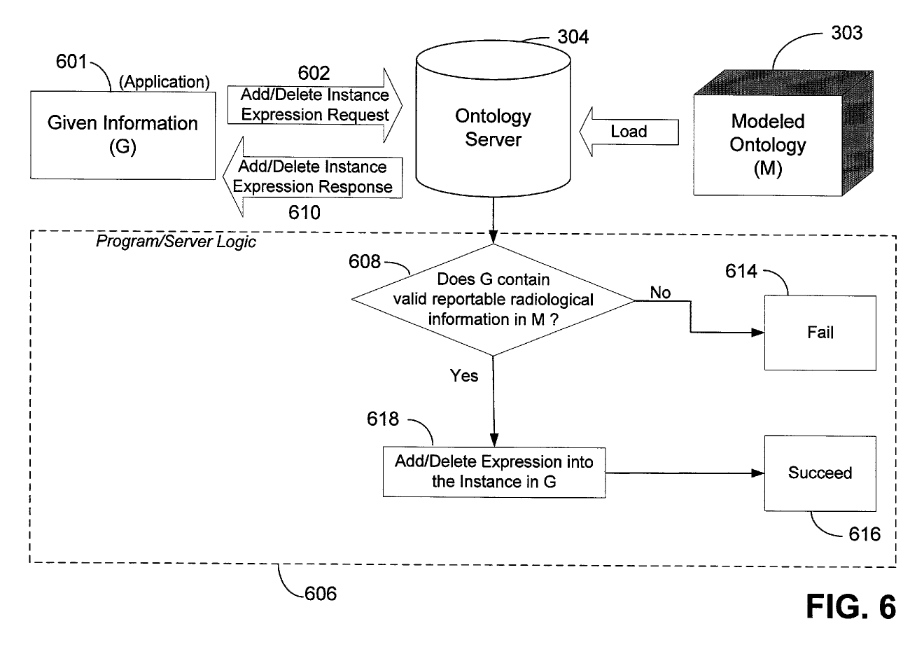

Turning to FIG. 6, in a relatively similar aspect of the present invention, a given information item may be added or deleted as an instance expression of the radiological information store in the ontology server 304. The deletion or addition of the information depends on whether or not such concept contains reportable radiological information within the modeled ontology M 303, as determined by server logic 606. In operation, an add/delete instance expression request 602 is initiated by an application 604 for given information G. Program/server logic 606 determines if G contains valid reportable radiological information in the modeled ontology M 303, at step 608. If the result of that determination is false, then a fail signal 614 is returned in the add/delete instance expression response 610, to the initiating application 604. Conversely, if the result of the determination is true, then a success signal 616 is generated and the appropriate action (i.e., addition or deletion) of the given information G is performed at step 618. Given information G is an instance expression of a reportable radiological concept.

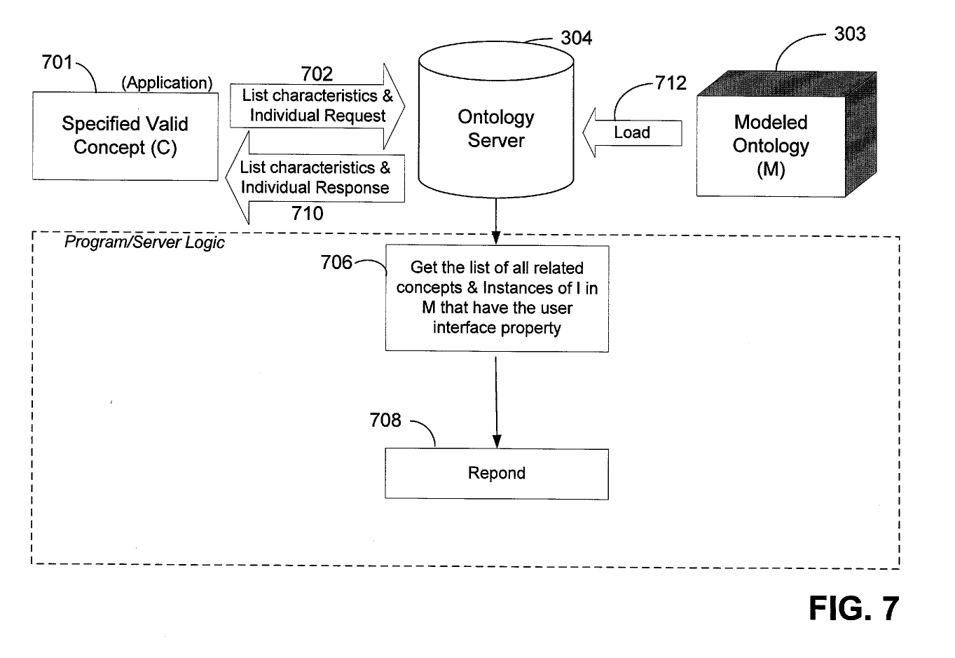

In an even further aspect, the present invention provides that for a specified valid report concept C, the modeled ontology M may be queried for all related concepts. Individual requests, as well as characteristic instances of the concept C are queried for all related concepts in the modeled ontology. The specified valid concept C is derived from the previously described operations wherein report information has been successfully validated in the radiological report domain ontology. As previously described, having a valid concept opens the door for further intelligent processing and predictive operations by the present invention. This feature is best understood with reference to the illustration of FIG. 7.

As shown, having a specified valid concept C 701, a request 702 may be initiated to list all characteristics and individuals. The request 702 is made to the ontology server 304. The server loads modeled ontology M 303 at step 712. At step 706, the program logic of the present invention obtains a list of from the modeled ontology M 303 of all related concepts and instances of the specified valid concept C 701 having a user interface property. At step 708, a response is initiated. The response includes providing a list of all characteristics and individual responses, at step 710.

To further illustrate an application of the various features and aspects of the invention, an implementation example of the above described invention is next described. In this implementation example, a radiological ontology for mammography is utilized.

Initially, the system and method of the present invention models non-radiological knowledge from patient information sources in the manner described earlier herein. That is to say that the knowledge of the mammography ontology is modeled as concepts, and object properties/relationships, with constraints on the concepts including those contained in one or more imported ontology. Concept properties are thus defined for a report domain ontology.

Using the system and methods described herein, the reporting application consults the report domain ontology about each piece of purported mammography radiological report information to validate that the information belongs to the mammography radiological report information domain. The application also receives the identity of the information and the classification for the sought after information.

The application examines the classification of each piece of information and if one informational item is classified as a mammography radiological concept, then the ontology is consulted in the context of the mammography radiological concept, and any relevant constraints or relationships are explored to validate the concept, i.e., determine whether the radiological report concepts apply to the radiological report currently in consideration.

These steps result in providing radiological report information that has been validated, identified and classified in the mammography report domain ontology.

The present invention, while described in the domain of mammography, is applicable to any report domain ontology in the field of radiology.

Having described the system and method of the present invention and an embodiment thereof, an exemplary computer environment for implementing the described design and execution is presented next.

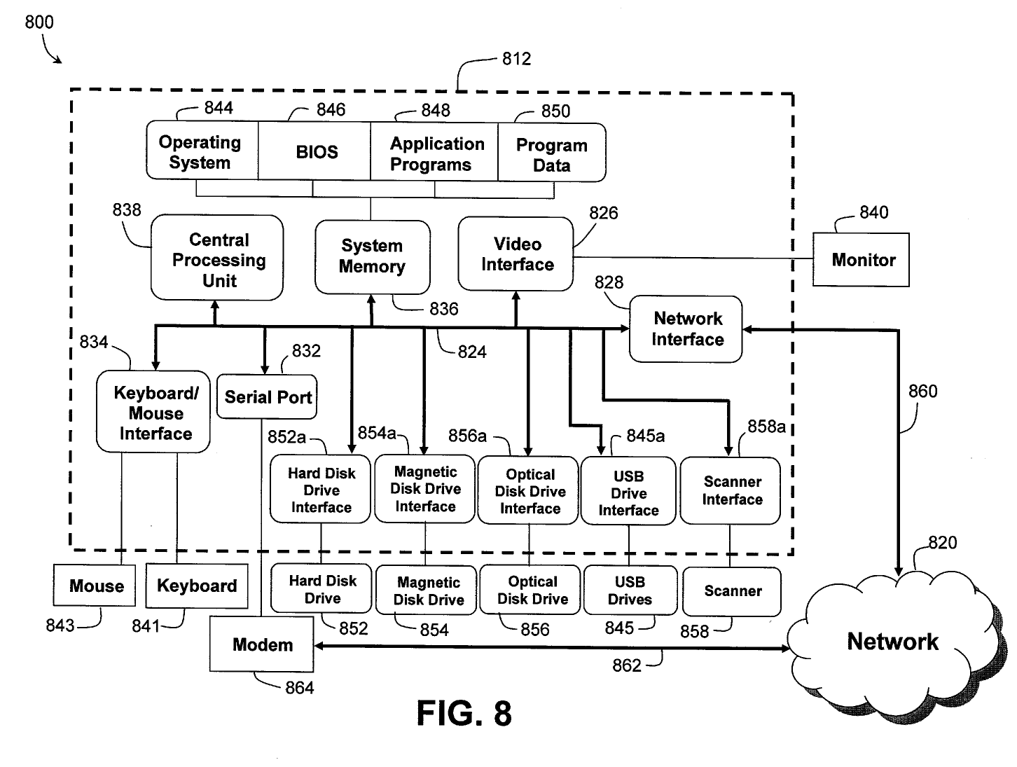

FIG. 8 shows an exemplary computing environment 800 that can be used to implement through programming, any of the processing thus far described. The computing environment may comprise a computer 812 including a system bus 824 that couples a video interface 826, network interface 828, one or more serial ports 832, a keyboard/mouse interface 834, and a system memory 836 to a Central Processing Unit (CPU) 838. Computer 812 may also include a Graphics Processing Unit (GPU) or one or more other special or general purpose processing units. A monitor or display 840 is connected to bus 824 by video interface 826 and provides the user with a graphical user interface to view, edit, and otherwise manipulate digital images. The graphical user interface allows the user to enter commands and information into computer 812 using a keyboard 841 and a user interface selection device 843, such as a mouse or other pointing device. Keyboard 841 and user interface selection device are connected to bus 824 through keyboard/mouse interface 834. The display 840 and user interface selection device 843 are used in combination to form the graphical user interface which allows the user to implement at least a portion of the present invention. Other peripheral devices may be connected to computer 812 through serial port 832 or universal serial bus (USB) drives 845 to transfer information to and from computer 812. For example, CT scanners, X-ray devices and the like may be connected to computer 812 through serial port 832 or USB drives 845 so that data representative of a digitally represented still image or video may be downloaded to system memory 836 or another memory storage device associated with computer 812 to enable processes and functions in accordance with the present invention.

The system memory 836 is also connected to bus 824 and may include read only memory (ROM), random access memory (RAM), an operating system 844, a basic input/output system (BIOS) 846, application programs 848 and program data 850. The computer 812 may further include a hard disk drive 852 for reading from and writing to a hard disk, a magnetic disk drive 854 for reading from and writing to a removable magnetic disk (e.g., floppy disk), and an optical disk drive 856 for reading from and writing to a removable optical disk (e.g., CD ROM or other optical media). The computer 812 may also include USB drives 845 and other types of drives for reading from and writing to flash memory devices (e.g., compact flash, memory stick/PRO and DUO, SD card, multimedia card, smart media card), and a scanner 858 for scanning items such as digital images to be downloaded to computer 812. A hard disk interface 852a, magnetic disk drive interface 854a, a optical drive interface 856a, a USB drive interface 845a, and a scanner interface 858a operate to connect bus 824 to hard disk drive 852, magnetic disk drive 854, optical disk drive 856, USB drive 845 and a scanner 858, respectively. Each of these drive components and their associated computer-readable media may provide computer 812 with non-volatile storage of computer-readable instruction, program modules, data structures, application programs, an operating system, and other data for the computer 812. In addition, it will be understood that computer 812 may also utilize other types of computer-readable media in addition to those types set forth herein, such as digital video disks, random access memory, read only memory, other types of flash memory cards, magnetic cassettes, and the like.

Computer 812 may operate in a networked environment using logical connections with image capture devices such as MRI, CT scanners, Ultrasound, Positron Emission Tomography (PET) or X-Ray devices. Network interface 828 provides a communication path 860 between bus 824 and network 820, which allows images to be communicated through network 820 from any of the previously identified imaging devices, and optionally saved in a memory, to the computer 812. This type of logical network connection is commonly used in conjunction with a local area network. Images may also be communicated from bus 824 through a communication path 862 to network 820 using serial port 832 and a modem 864. Using a modem connection between the computer 812 and imaging devices may be used in conjunction with a wide area network or the Internet. It will be appreciated that the network connections shown herein are merely exemplary, and it is within the scope of the present invention to use other types of network connections between computer 812 and imaging devices including both wired and wireless connections.

The present invention provides a useful, novel and non-obvious means to utilize radiological report domain ontology to validate, identify and classify radiological information for reports. In other words, it provides means to determine what informational items are allowable and/or belong in a given report.

The present invention provides verification of the process and procedures pertaining to a patient as a part of the reporting process. For example, the system of the present invention can verify that the reasons for the request of a particular examination or study have been addressed in the final report, thereby ensuring more complete reports.

Additionally, the present invention provides a tool that may be utilized by other applications or systems as a building block for further information processing.

From the foregoing, it will be seen that this invention is one well adapted to attain all the ends and objectives hereinabove set forth together with other advantages which are obvious and which are inherent to the method and apparatus. It will be understood that certain features and sub-combinations are of utility and may be employed without reference to other features and sub-combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed, as the best mode contemplated for carrying out this invention, but that the invention will include all embodiments falling within the scope and spirit of the appended claims.

What is claimed is:

1. A method programmed in a computing environment for providing radiological reporting, the method comprising:
importing non-radiological knowledge pertaining to a patient;
importing a radiological information ontology;
defining said non-radiological knowledge as report domain concepts of said radiological information ontology;
identifying relationships between said report domain concepts;
identifying constraints on said report domain concepts; and
employing said domain concept to report said patient's information;
whereby radiological report information items may be identified, classified and validated in the context of said radiological information ontology.

2. A method programmed in a computing environment for consulting and providing report information from, a radiological domain ontology in reference to a subject, the method comprising:
defining one or more aspects of radiology report information as concept properties represented by a vocabulary of one or more instances of said radiological domain ontology, said radiological domain ontology declaring and fulfilling a model of radiological domain knowledge;
wherein said model of radiological domain knowledge comprises:
one or more findings;
one or more finding characteristics; and
object properties, wherein said object properties represent relationships among said findings and finding characteristics;
providing a non-radiological informational item of interest that relates to said subject;
employing a context that defines a set of said domain knowledge and the relationships among said set of domain knowledge to describe said subject;
validating said informational item is reportable radiological information and resides in said domain of knowledge;
identifying definitive concept of said informational item from within said domain of knowledge; and
classifying said informational item.

3. The method of claim 2 wherein said classifying, identifies or defines said informational item as a finding or finding characteristic.

4. The method of claim 2 further comprising validating that said informational item is within a specific radiological report context.

5. The method of claim 2 further comprising adding a new radiological report concept as an instance or instance expression to said radiological domain ontology.

6. The method of claim 2 further comprising, deleting an instance or instance expression of an existing radiological concept from said radiological domain ontology.

7. The method of claim 2 further comprising, providing a list of containers and container items, wherein a container is a characteristic concept and container items are individual finding characteristics that have applicability to a user interface for a given radiological finding concept.

8. The method of claim 2 wherein said radiology report information item is derived from clinical information.

9. The method of claim 2 wherein said radiology report information item is derived from meta-history.

10. The method of claim 2 wherein said radiology report information item is derived from patient demographic data.

11. A method programmed in a computing environment for identifying, validating and classifying one or more radiological report informational items, utilizing a radiological report domain ontology in reference to a subject, the method comprising:
defining one or more aspects of non-radiological functions as concept properties represented by a vocabulary of one or more instances of said radiological report domain ontology, said radiological report domain ontology declaring and fulfilling a model of radiological domain knowledge;
receiving an informational report item of interest that relates to said subject;
wherein said radiological report domain knowledge comprises:
a plurality of findings;
a plurality of finding characteristics; and
object properties, wherein said object properties represent relationships among said plurality of findings and said plurality of finding characteristics;
employing a context that defines a set of said radiological report domain knowledge and the relationships among said set of radiological report domain knowledge to describe said subject;
wherein said validating determines that said informational item is radiological and resides in said radiological report domain knowledge;
wherein said identifying determines a definitive concept of said informational item from within said radiological report domain knowledge; and
wherein classifying said informational item determines that said informational item is one of said plurality of findings or one of said plurality of finding characteristics.

12. A computing system for identifying, validating and classifying one or more radiological report informational items, utilizing a radiological report domain ontology in reference to a subject comprising:
a definition of one or more aspects of radiology reports as concept properties represented by a vocabulary of one or more instances of said radiological report domain ontology, said radiological report domain ontology declaring and fulfilling a model of radiological report domain knowledge;
means for receiving an informational report item of interest that relates to said subject;
a context that employs a set of said domain knowledge and the relationships among said set of radiological report domain knowledge to describe said subject;
a validation module to determine that said informational report item is radiological and resides in said radiological report domain knowledge;
an identification module to determine a definitive concept of said informational report item from within said radiological report domain knowledge; and
a classification module for determining that said informational report item is a finding or a finding characteristic, within said radiological report domain knowledge;
wherein said radiological report domain knowledge comprises:
one or more findings;
one or more finding characteristics; and
object properties,
wherein said object properties represent relationships among said findings and finding characteristics.
